(19) United States
(12) Patent Application Publication
(10) Pub. No.: US 2012/0169730 A1
(43) Pub. Date: Jul. 5, 2012

(54) 3D IMAGE DISPLAY DEVICE AND 3D IMAGE DISPLAY METHOD

(75) Inventor: Kazunori Inoue, Tokyo (JP)

(73) Assignee: PANASONIC CORPORATION, Osaka (JP)

(21) Appl. No.: 13/395,987

(22) PCT Filed: May 7, 2010
(86) PCT No.: PCT/JP2010/003141

§ 371 Date: Mar. 14, 2012

(30) Foreign Application Priority Data
Sep. 28, 2009 (JP) 2009-223029

(51) Int. Cl. G06T 15/00

(52) U.S. Cl. 345/419

(57) ABSTRACT

Provided is a 3D image display method by which a viewer can more comfortably view a 3D image using an image stream for 3D viewing. The 3D image display method is a method used in a 3D image display device for displaying a 3D image from an image stream for 3D viewing including an image for a left eye and an image for a right eye, using a screen and 3D viewing glasses. The method comprises a step for acquiring, as glasses information, either the position and/or the inclination of the 3D viewing glasses with respect to the screen (S1200), a step for determining whether or not the glasses information satisfies an appropriate viewing condition under which a viewer wearing the 3D viewing glasses can view the 3D image (S1300), a step for correcting either the size and/or the position of either the image for the left eye and/or the image for the right eye (S1400-S1700) when the glasses information does not satisfy the appropriate viewing condition (S1300: NO), and a step for outputting the image to the screen (S1800).

### TECHNICAL FIELD

The present invention relates to a twin-lens three-dimensional image display apparatus and three-dimensional image display method that display a three-dimensional image by presenting different images to a viewer's right eye and left eye via an auxiliary optical device such as a pair of glasses.

### BACKGROUND ART

In recent years, three-dimensional (3D) image technology has attracted attention. When a person views a 3D object with the naked eye, an image seen by the right eye and an image seen by the left eye have a minute degree of difference (parallax) due to the difference in the positions of the left and right eyeballs. That is to say, a person sees slightly different images (object shapes) with the left eye and right eye. A characteristic of human beings is that, when images of shapes that differ in the same kind of way as this are seen with the left eye and right eye, even if a viewed object is not actually 3D, the viewer feels just as if is he or she is viewing a 3D object. Various kinds of 3D viewing apparatuses have been proposed that make use of this characteristic to display a 3D object by displaying an image (hereinafter referred to as a “parallax image”) composed of a left-eye image and right-eye image that differ.

One kind of 3D viewing apparatus that has been proposed is an apparatus that uses an auxiliary optical device in the form of a pair of glasses (hereinafter referred to as “3D viewing glasses”). This apparatus displays a parallax image on a display apparatus and provides a left-eye image and right-eye image to a viewer's left and right eyes respectively through the use of 3D viewing glasses.

One actual example of a 3D viewing apparatus is an apparatus that displays a parallax image in different colors such as red and blue, and separates the images of the parallax image with color filters of 3D viewing glasses. Another actual example of a 3D viewing apparatus is an apparatus that displays a parallax image with differing polarization states, and separates the images of the parallax image with polarization filters of 3D viewing glasses. Yet another actual example of a 3D viewing apparatus is an apparatus that displays a parallax image using time division, and separates the images of the parallax image by means of a liquid crystal shutter of 3D viewing glasses synchronized with switching of the images.

In the case of a 3D image display apparatus that uses 3D viewing glasses, an actual parallax image displayed on an image display screen (hereinafter referred to as “screen”) of a display apparatus is an image projected in a fixed position in the same way as with an ordinary television apparatus. Consequently, images presented to a viewer's left and right eyes change according to the viewer's position and posture.

Specifically, the situation is as follows. Consider, for example, a case in which viewer 10 views parallax image 30 from a left or right diagonal position rather than from directly in front, as shown in FIG. 1A. In this case, as shown in FIG. 1B, image (for example, right-eye image) 31 nearer viewer 10 appears larger to viewer 10, and image (for example, left-eye image) 32 farther from viewer 10 appears smaller. This is because, in the case of a 3D image display apparatus, unlike when viewer 10's eyes view a normal 3D object, artificially generated images are forcibly conveyed to the left and right eyes respectively.

Consider also, for example, a case in which viewer 10's face is inclined, and the lateral direction of the face is inclined greatly from the lateral direction of screen 20, as shown in FIG. 2A. In this case, right-eye image 31 and left-eye image 32 appear to viewer 10 to be vertically displaced, as shown in FIG. 2B.

In the case of a normal 2D image that is a planar object, even if the phenomena shown in FIG. 1B and FIG. 2B occur, the situation is exactly the same as when a person views a normal planar object with both eyes. Therefore, in this case, there is no problem with regard to vision or cognition. However, in the case of a parallax image, there are problems with regard to vision and cognition. This is because, since an image of an object is normally provided to the left and right eyes at the same size and the same height, it is difficult for a person to recognize images provided to the left and right eyes at different sizes or different heights as being images of the same object.

Therefore, when viewer 10 views parallax image 30 from a diagonal position relative to screen 20, or views parallax image 30 with his or her face inclined relative to screen 20, a state greatly conflicting with a state in which a 3D object is actually viewed is established in the eyes and brain of viewer 10. Thus, a problem of not being able to see an object as an expected 3D object, and a problem of a growing sense of discomfort or fatigue during a long period of viewing, may arise. Below, the above problem due to viewing parallax image 30 from a diagonal position relative to screen 20 is referred to as the “diagonal position problem.” Also, the above problem due to viewing parallax image 30 with one's face inclined relative to screen 20 is referred to as the “inclination problem.”

An example of a technology that has been proposed to alleviate the diagonal position problem is an apparatus whereby a virtual screen directly in front of a viewer is set, and an image output to an actual screen is deformed in accordance with the set virtual screen (see Patent Literature 1, for example). Specifically, this apparatus performs image conversion processing that changes a rectangle to a trapezoid on a parallax image. By this means, when the apparatus described in Patent Literature 1 converts an actual screen that appears trapezoidal to a viewer to a rectangular virtual screen, an original parallax image can be displayed in a similar state to when viewed from directly in front.

Also, an example of a technology that has been proposed to alleviate the inclination problem is an apparatus whereby the inclination of 3D viewing glasses is detected by a parallax image generation apparatus using 3D computer graphics, and parallax image generation is changed according to the inclination (see Patent Literature 2, for example). Specifically, this apparatus draws (renders) a left-eye image and right-eye image of a solid figure in real time according to the position and posture of 3D viewing glasses. By this means, the apparatus described in Patent Literature 2 can display a natural 3D image.

### CITATION LIST

### Patent Literature

### PTL 1

Japanese Patent Application Laid-Open No. 2006-333400

### PTL 2

Japanese Patent Application Laid-Open No. 2006-84963

### SUMMARY OF INVENTION

### Technical Problem

However, a problem with the technology described in Patent Literature 1 is a lack of comfort when viewing. The reason is as follows. When viewing an object in an image, a person recognizes the shape of the object, based on a relative relationship to an object peripheral to the screen (for example, the frame of a display). Therefore, when a diagonal display frame image and a parallax image directly in front can be seen, an object in the parallax image appears to be distorted to a viewer. That is to say, with a method whereby an image is distorted into a trapezoid when viewed from a diagonal position, even though the geometrical shape of an image can be maintained, a feeling similar to that when viewing a conventional display that displays a 2D image cannot be conveyed to a viewer. Therefore, a parallax image displayed by means of the technology described in Patent Literature 1 may actually give a viewer a sense of discomfort.

Also, a problem with the technology described in Patent Literature 2 is that it cannot be applied to an image stream for 3D viewing comprising a left-eye image and right-eye image created beforehand. In recent years, movies and image content comprising an image stream for 3D viewing have become widely used, and demand has arisen for a method of solving the inclination problem for an image stream.

Furthermore, a problem with the technologies described in Patent Literature 1 and Patent Literature 2 is that they are not suitable for a case in which there are a plurality of viewers. As shown in FIG. 3, when four viewers 10-1 through 10-4, for example, are viewing the same screen 20, the position and the inclination of the face normally differ for each viewer 10. Solving the diagonal position problem and inclination problem for all of viewers 10-1 through 10-4 is difficult. Below, the above problem due to differences in position and inclination of the face of a plurality of viewers is referred to as the “multiple viewer problem.”

It is an object of the present invention to provide a 3D image display apparatus and 3D image display method that enable a viewer to view more comfortably a 3D image using an image stream for 3D viewing.

### Solution to Problem

A 3D image display apparatus of the present invention displays a 3D image from an image stream for 3D viewing that includes a left-eye image and a right-eye image, using a screen and 3D viewing glasses, and has: an appropriate viewing condition setting section that sets an appropriate viewing condition under which a viewer wearing the 3D viewing glasses can view a 3D image; a glasses information acquisition section that acquires, as glasses information, at least one of the position and inclination of the 3D viewing glasses relative to the screen; and an image correction section that, when the glasses information does not satisfy the appropriate viewing condition, performs correction of at least one of the size and the position for at least one of the left-eye image and the right-eye image, and outputs the image to the screen.

A 3D image display apparatus of the present invention displays a 3D image from an image stream for 3D viewing that includes a left-eye image and a right-eye image, using a screen and 3D viewing glasses, and has: an appropriate viewing condition setting section that sets an appropriate viewing condition under which a viewer wearing the 3D viewing glasses can view a 3D image; a glasses information acquisition section that acquires, as glasses information, at least one of the position and inclination of the 3D viewing glasses relative to the screen; and a notification section that performs predetermined notification to a viewer wearing the 3D viewing glasses when the glasses information does not satisfy the appropriate viewing condition.

A 3D image display method of the present invention displays a 3D image from an image stream for 3D viewing that includes a left-eye image and a right-eye image, using a screen and 3D viewing glasses, and has: a step of acquiring, as glasses information, at least one of the position and inclination of the 3D viewing glasses relative to the screen; a step of determining whether or not the glasses information satisfies an appropriate viewing condition under which a viewer wearing the 3D viewing glasses can view a 3D image; and a step of performing predetermined notification to a viewer wearing the 3D viewing glasses when the glasses information does not satisfy the appropriate viewing condition.

### Advantageous Effects of Invention

The present invention enables a viewer to view more comfortably a 3D image using an image stream for 3D viewing.

### BRIEF DESCRIPTION OF DRAWINGS

FIG. 1 is a drawing for explaining a diagonal position problem in the case of a conventional 3D image display apparatus;

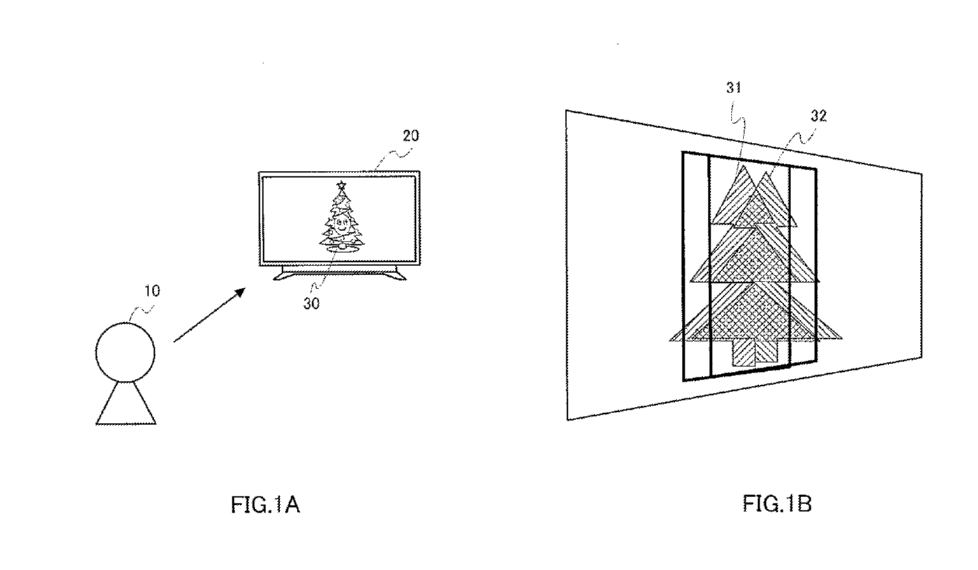

FIG. 2 is a drawing for explaining an inclination problem in the case of a conventional 3D image display apparatus;

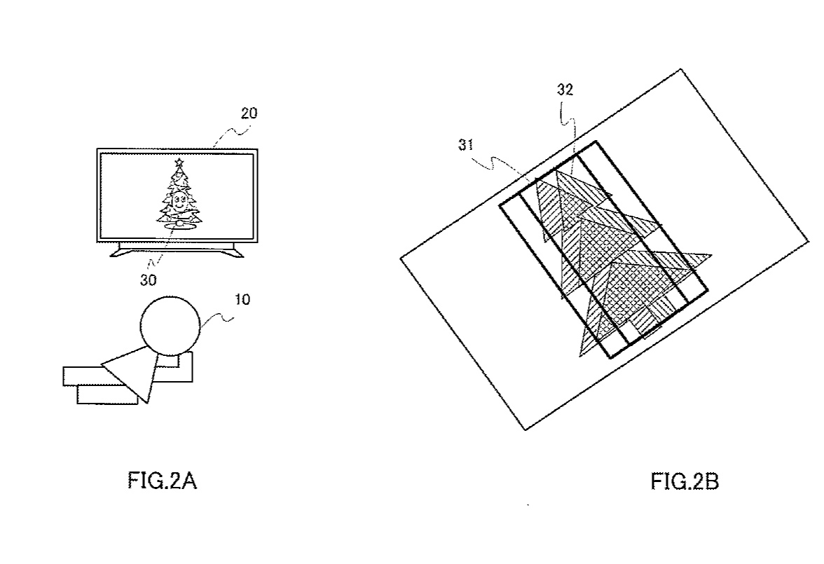

FIG. 3 is a drawing for explaining a multiple viewer problem in the case of a conventional 3D image display apparatus;

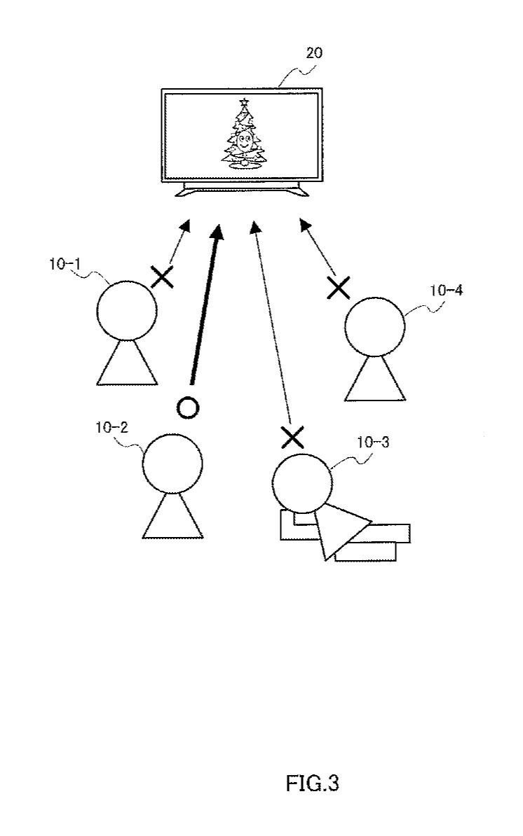

FIG. 4 is a system configuration diagram showing an example of the configuration of a 3D image display system that includes a 3D image display apparatus according to Embodiment 1 of the present invention;

FIG. 5 is a first drawing explaining parameters in Embodiment 1;

FIG. 6 is a second drawing explaining parameters in Embodiment 1;

FIG. 7 is a third drawing explaining parameters in Embodiment 1;

FIG. 8 is a block diagram showing an example of the configuration of a 3D image display apparatus according to Embodiment 1;

FIG. 9 is an external view of an example of the configuration of 3D viewing glasses in Embodiment 1;

FIG. 10 is a flowchart showing an example of the operation of a 3D image display apparatus according to Embodiment 1;

FIG. 11 is a drawing showing an example of an image stream parallax image in Embodiment 1;

FIG. 12 is a drawing for explaining parallel movement processing in Embodiment 1;

FIG. 13 is a drawing for explaining scaling (enlargement/reduction) processing in Embodiment 1;

FIG. 14 is a block diagram showing an example of the configuration of a 3D image display apparatus according to Embodiment 2 of the present invention;

FIG. 15 is a flowchart showing an example of the operation of a 3D image display apparatus according to Embodiment 2;

FIG. 16 is a block diagram showing an example of the configuration of a 3D image display apparatus according to Embodiment 3 of the present invention;

FIG. 17 is a flowchart showing an example of the operation of a 3D image display apparatus according to Embodiment 3;

FIG. 18 is a block diagram showing an example of the configuration of a 3D image display apparatus according to Embodiment 4 of the present invention;

FIG. 19 is a flowchart showing an example of the operation of a 3D image display apparatus according to Embodiment 4; and

FIG. 20 is a drawing showing an example of the nature of glasses control in Embodiment 4.

### DESCRIPTION OF EMBODIMENTS

Now, embodiments of the present invention will be described in detail with reference to the accompanying drawings.

### Embodiment 1

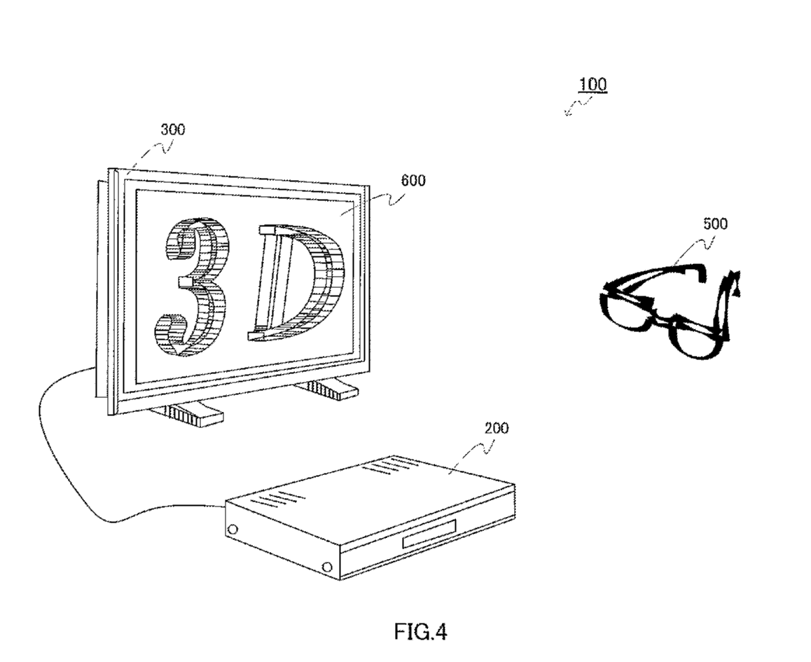

FIG. 4 is a system configuration diagram showing an example of the configuration of a 3D image display system that includes a 3D image display apparatus according to Embodiment 1 of the present invention. The present embodiment is an example of application of the present invention to a liquid crystal shutter type of 3D image display system.

In FIG. 4, 3D image display system 100 has image playback apparatus 200, 3D image display apparatus 300, and 3D viewing glasses (hereinafter referred to simply as “glasses”) 500.

Image playback apparatus 200 is a device provided with an image data playback function, such as a Blu-ray disc (registered trademark) player, for example. Image playback apparatus 200 plays back a 3D-image parallax-image image stream from a Blu-ray disc (registered trademark) or such like recording medium or a received signal or the like. Image playback apparatus 200 outputs a played-back image stream to 3D image display apparatus 300. An image stream includes a left-eye image and right-eye image (that is, a parallax image).

3D image display apparatus 300 is a device provided with a liquid crystal shutter type of 3D image display function, such as a television, for example. 3D image display apparatus 300 displays a parallax image on screen 600, based on an image stream input from image playback apparatus 200. More specifically, 3D image display apparatus 300 displays a left-eye image and right-eye image on the same screen 600 while switching between the images at high speed in frame units, for example (frames being single images that make up a moving image). Image playback apparatus 200 transmits to glasses 500 a synchronization signal for controlling the light transmission state of the left and right lenses of glasses 500.

3D image display apparatus 300 also sets an appropriate viewing condition. Here, an appropriate viewing condition is a range of positions and inclinations of glasses 500 in which a viewer wearing glasses 500 (hereinafter referred to simply as “viewer”) can view a 3D image (hereinafter referred to as “appropriate viewing range”). Details of an appropriate viewing condition will be given later. Then 3D image display apparatus 300 acquires the position and inclination of glasses 500 (glasses information). 3D image display apparatus 300 determines whether or not the acquired position and inclination of glasses 500 satisfy the appropriate viewing condition. In the event of determining that the appropriate viewing condition is not satisfied, 3D image display apparatus 300 corrects at least one of the size and position of at least one of the image stream left-eye image and right-eye image before performing display on screen 600. That is to say, 3D image display apparatus 300 corrects a displayed parallax image in such a way that the above-described diagonal position problem and inclination problem are alleviated. An appropriate viewing condition will be described later.

Glasses 500 are an optical device worn by a viewer viewing a 3D image, and may be liquid crystal shutter type glasses, for example. Glasses 500 switch the light transmission state of their left and right lenses in accordance with a synchronization signal received from 3D image display apparatus 300. In the case of liquid crystal shutter type glasses, glasses 500 perform this switching by means of liquid crystal shutter drive control.

As a result, for example, when a left-eye image is displayed on 3D image display apparatus 300, glasses 500 place the left lens in a light transmission state and the right lens in a light exclusion state. And when a right-eye image is displayed on 3D image display apparatus 300, glasses 500 place the right lens in a light transmission state and the left lens in a light exclusion state. That is to say, glasses 500 can place only the left lens in a light transmission state in an instant in which a left-eye image appears on 3D image display apparatus 300. And glasses 500 can place only the right lens in a light transmission state in an instant in which a right-eye image appears on 3D image display apparatus 300.

By using 3D image display system 100 of this kind, a viewer can view only a left-eye image with the left eye, and only a right-eye image with the right eye. As a result, a viewer can view a 3D image. Also, a viewer can view a 3D image in a state in which the above-described diagonal position problem and inclination problem are alleviated, and can view a 3D image more comfortably.

Various parameters used by 3D image display system 100 will now be described.

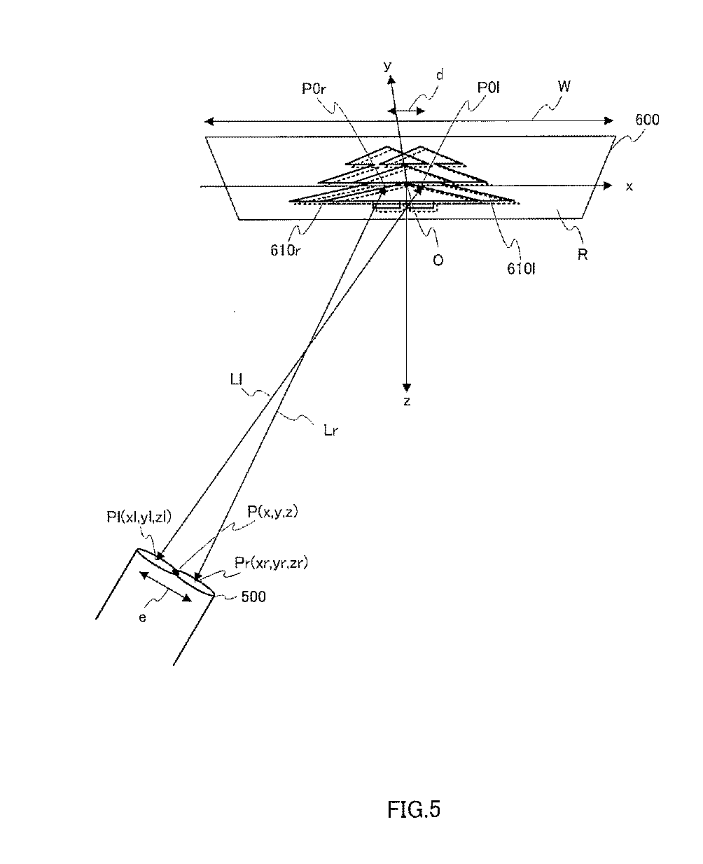

FIG. 5 through FIG. 7 are drawings explaining parameters used by 3D image display system 100.

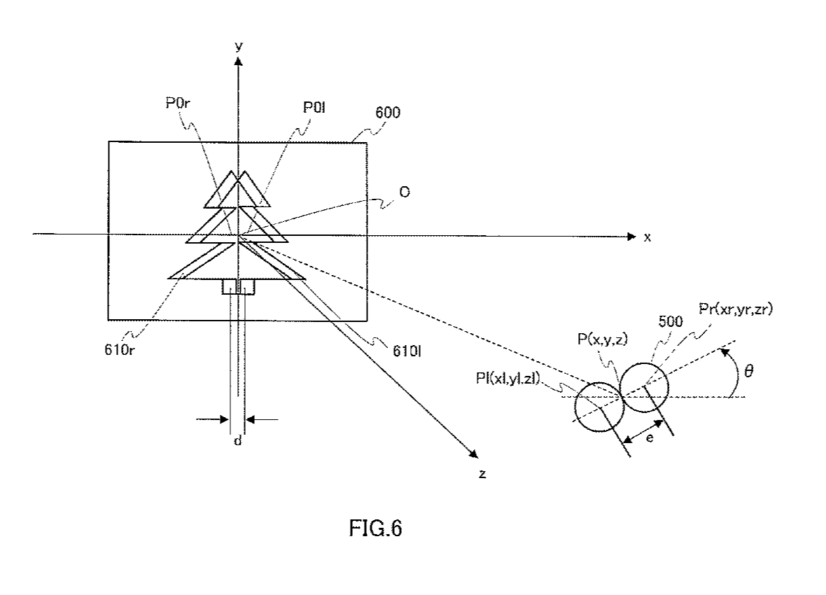

As shown in FIG. 5 and FIG. 6, 3D image display system 100 uses the following parameters: display actual width W, screen resolution R, reference parallax d, glasses information, glasses baseline length e, left-eye line of sight distance Ll, and right-eye line of sight distance Lr. Glasses information includes left lens position Pl (xl, yl, zl), right lens position Pr (xr, yr, zr), glasses position P (x, y, z), and glasses inclination angle θ. Also, in the following description, a line linking left lens position Pl to right lens position Pr is referred to as the “glasses baseline.” And the direction of the glasses baseline is referred to as the “glasses baseline direction.”

Display actual width W is the horizontal size of screen 600, and is normally a value that is a fixed default value for each television model.

Screen resolution R denotes the number of pixels per unit length. Screen resolution R can be obtained, for example, by dividing the number of horizontal pixels of a parallax image by display actual width W. The number of horizontal pixels of a parallax image is normally a known value determined by the image format of a parallax image. For example, in the case of a 1920-pixel-width full HD (High Definition) format, the number of horizontal pixels of a parallax image is obviously 1920.

Reference parallax d is a representative value of parallax present in an original parallax image, and is a parameter indicating parallax that is a reference for parallax image correction. For example, reference parallax d is an amount of displacement on screen 600 between reference point P0l of left-eye-image reference image (hereinafter referred to as “left-eye reference image”) 610l and reference point P0r of right-eye-image reference image (hereinafter referred to as “right-eye reference image”) 610r. Reference images 610 and reference points will be described later.

In the coordinate system used here, the midpoint between reference point P0l of left-eye reference image 610l and reference point P0r of right-eye reference image 610r is taken as origin O, the normal direction of screen 600 is defined as the z axis, the vertical direction as the y axis, and the right direction facing screen 600 as the x axis.

Left lens position Pl (xl, yl, zl) is a glasses 500 position corresponding to the viewer's left pupil.

Right lens position Pr (xr, yr, zr) is a glasses 500 position corresponding to the viewer's right pupil.

Glasses position P (x, y, z) is a glasses 500 representative position, and is here assumed to be the midpoint between left lens position Pl and right lens position Pr.

Glasses baseline length e is the distance between glasses 500 left lens position Pl and right lens position Pr.

Left-eye line of sight distance Ll is the distance from left lens position Pl to reference point P0l of left-eye reference image 610l on screen 600.

Right-eye line of sight distance Lr is the distance from right lens position Pr to reference point P0r of right-eye reference image 610r on screen 600.

As shown in FIG. 6, glasses inclination angle θ is the angle between a line obtained by projecting a glasses baseline onto screen 600 and a horizontal plane. In the following description, the glasses baseline direction is assumed to be parallel to screen 600 unless explicitly stated otherwise.

A left-eye image and right-eye image making up a parallax image are normally images that reproduce respectively an image visible from the left-eye position and an image visible from the right-eye position when a viewer views a 3D object directly. A part of a parallax image to the right of a right-eye image in a left-eye image appears to stand out farther forward than screen 600. Conversely, a part of a parallax image to the left of a right-eye image in a left-eye image appears to be farther back than screen 600. Also, the greater the parallax, the greater the distance from screen 600 appears to be. A part with zero parallax appears to be in the same position as screen 600. That is to say, a part with zero parallax appears the same as in the case of a 2D image.

A person's eyes have difficulty in adjusting their focal point to a plurality of distances or a plurality of points, or over a wide range, at one time, and normally focus on a particular extremely limited depth and field of view at each point in time. This is also the case when viewing a parallax image on screen 600. Here, an image part that an image creator intends to be focused on by a viewer is assumed to be an above-described “reference image.”

When viewing a reference image, also, a person's eyes similarly adjust their focal point to one point in a reference image at each point in time. Here, a point to which an image creator intends a viewer to adjust the focal point of his or her eyes is assumed to be an above-described “reference point.”

A sense of depth felt by a person with respect to a reference image is normally determined by the parallax of a reference point. Therefore, 3D image display apparatus 300 acquires parallax of reference point P0 of reference image 610—that is, the distance between reference point P0l and reference point P0r —as reference parallax d. Then 3D image display apparatus 300 also maintains acquired reference parallax d in a post-correction parallax image.

Such a reference image and reference point are present in many scenes of various kinds of created content represented by a movie. A reference image is, for example, a facial image part of a featured person or an image part of a prominent object such as a tree. A reference point is, for example, a pupil of a featured person or a center point of an object. Here, a description is given assuming that reference image 610 and reference parallax d are present at each time in a parallax image.

If information indicating reference parallax d at each time is attached to a parallax-image image stream, it is possible to obtain reference parallax d from the image stream. Also, if information indicating the number of pixels (hereinafter referred to as “the number of parallax pixel”) equivalent to reference parallax d is attached to an image stream, it is also possible to obtain reference parallax d from this number of parallax pixel. Furthermore, reference parallax d can be decided by rule of thumb or fixed at an acquired value according to the contents of an image stream.

Also, if information indicating a reference point at each time is attached to a parallax-image image stream, reference parallax d can be obtained from the distance between reference point P0l of left-eye reference image 610l and reference point P0r right-eye reference image 610r on screen 600. Moreover, if information indicating reference image 610 at each time is attached to a parallax-image image stream, it is possible for reference parallax d to be calculated sequentially based on the position of reference image 610. In this case, reference parallax d can be obtained, for example, from the distance between the center point of left-eye reference image 610l and the center point of right-eye reference image 610r.

Also, reference parallax d can be obtained, by extracting the same figure from a left-eye image and a right-eye image and calculating the distance between the positions of these figures on screen 600. On the other hand, many figures for which parallax differs are generally included in 3D image content. Therefore, provision may also be made for reference parallax d to be obtained by finding the maximum value or average value of a plurality of parallaxes obtained for a plurality of figures.

Below, the distance between reference point P0l of left-eye reference image 610l and reference point P0r of right-eye reference image 610r on screen 600 is referred to as “image parallax,” and a line passing through these reference points P0l and P0r is referred to as an “image baseline.” Also, the direction of an image baseline is referred to as the “image baseline direction” (parallax direction).

An appropriate viewing condition will now be described.

As described above, when a viewer's position is significantly distant from a position directly in front of a screen, or when the lateral direction of a viewer's face is significantly inclined from the horizontal direction, there is a possibility of a diagonal position problem and inclination problem arising.

On the other hand, the human brain has a certain degree of tolerance with regard to 3D (stereoscopic) vision, and it is known that there is a certain permissible latitude in facial positions and inclinations at which a 3D image can be viewed appropriately. For example, it is known from experimentation and so forth that many viewers recognize a reference image as a 3D image with hardly any problem, in the case of an image size difference of 15% or less and an image inclination angle of between −6 degrees and +6 degrees.

Here, “image size difference” denotes a relative difference in size of a right-eye reference image with respect to a left-eye reference image reaching the eyes. And “image inclination angle” denotes a relative angle of inclination of an image baseline direction with respect to the lateral direction of the face (glasses baseline direction).

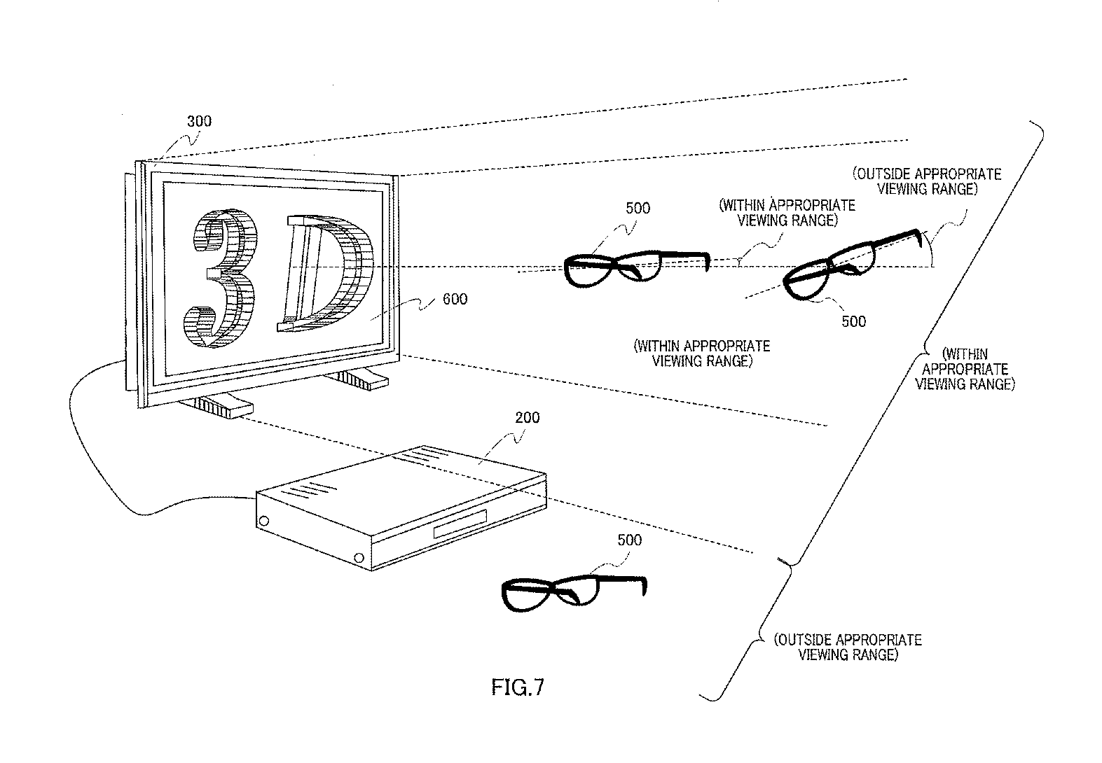

Thus, in the present embodiment, that the position and inclination of glasses 500 are within a range allowing a 3D image to be viewed appropriately (an appropriate viewing capability range), as shown in FIG. 7, is used as an appropriate viewing condition. Specifically, an appropriate viewing capability range is, for example, a set of combinations of glasses position and glasses inclination angle such that the image size difference is 15% or less, and the image inclination angle is between −6 degrees and +6 degrees, with respect to a predetermined reference image.

An appropriate viewing condition can be defined, for example, by equations 1 and 2 below. Here, θth is the absolute value of a maximum permitted value of an image inclination angle for avoiding the diagonal position problem—for example, 6 degrees. D is an image size difference. Dth is a maximum permitted value of an image inclination angle for avoiding the inclination problem—for example, 0.85 (a difference of 15 percent). The reason why image size difference D is equal to the ratio of left-eye line of sight distance Ll to right-eye line of sight distance Lr is that the size of an image formed on the eye is inversely proportional to the distance of an object from the eye.

$$\begin{matrix}( Equation 1 ) & \\ \vert θ \vert < θ th & [ 1 ] \\ ( Equation 2 ) & \\ \frac{1}{Dth} \leq D = \frac{Ll}{Lr} < Dth & [ 2 ]\end{matrix}$$

The configuration of each apparatus will now be described.

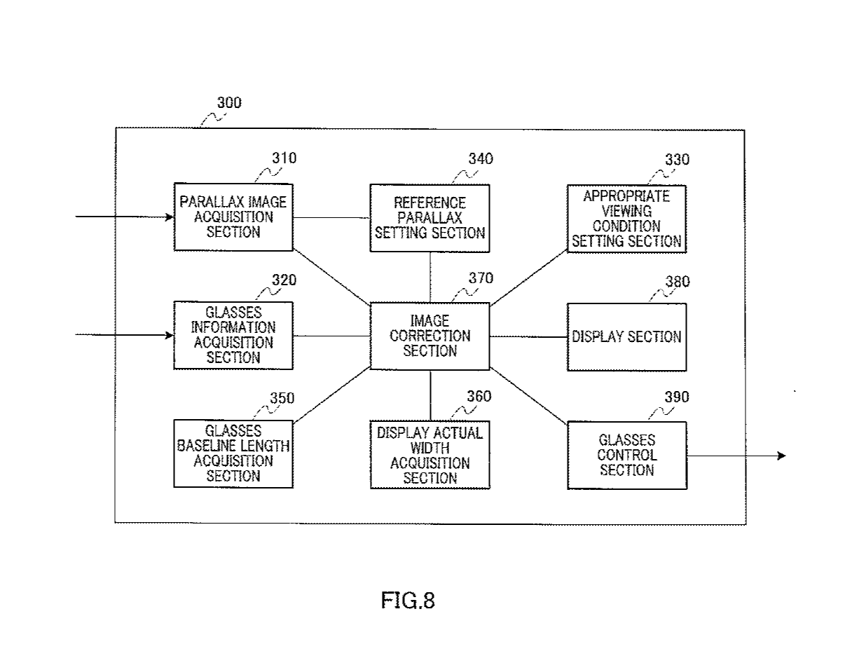

FIG. 8 is a block diagram showing an example of the configuration of 3D image display apparatus 300.

In FIG. 8, 3D image display apparatus 300 has parallax image acquisition section 310, glasses information acquisition section 320, appropriate viewing condition setting section 330, reference parallax setting section 340, glasses baseline length acquisition section 350, display actual width acquisition section 360, image correction section 370, display section 380, and glasses control section 390. When 3D image display apparatus 300 is a television, it is also provided with sections other than the above, such as a power supply section, operating section, broadcast transmission/reception section, image input/output section, and audio input/output section, but illustrations and descriptions thereof will be omitted.

Parallax image acquisition section 310 inputs a parallax-image image stream from image playback apparatus 200. Parallax image acquisition section 310 sequentially outputs an input image stream to reference parallax setting section 340 and image correction section 370 in frame units.

Glasses information acquisition section 320 sequentially acquires radio signals from glasses 500. Glasses information acquisition section 320 calculates glasses information from an acquired radio signal, and outputs the calculation result to image correction section 370. Glasses information includes glasses position P, left lens position Pl, right lens position Pr, and glasses inclination angle θ (see FIG. 5 and FIG. 6).

Here, glasses information acquisition section 320 is assumed to perform radio communication between a plurality of UWB (Ultra Wide Band) antennas installed in 3D image display apparatus 300 and two UWB antennas installed in glasses 500. Glasses information acquisition section 320 calculates the distance between the UWB antennas based on the round trip time of a radio signal, calculates the positions of the glasses 500 UWB antennas by means of triangulation, and calculates the above glasses information from the positions of the glasses 500 UWB antennas.

Appropriate viewing condition setting section 330 sets a glasses position P range and glasses inclination angle θ range allowing a viewer to view a 3D image as an appropriate viewing condition. Then appropriate viewing condition setting section 330 outputs the set appropriate viewing condition to image correction section 370.

Appropriate viewing condition setting section 330 may set an appropriate viewing condition by, for example, using a preset fixed glasses position P range and glasses inclination angle θ range. Alternatively, appropriate viewing condition setting section 330 may, for example, store a table that associates a display model with an appropriate viewing condition beforehand, and acquire an appropriate viewing condition corresponding to information indicating the 3D image display apparatus 300 model from this table. Here, it is assumed that appropriate viewing condition setting section 330 sets a fixed appropriate viewing range (FIG. 7) as an appropriate viewing condition.

Reference parallax setting section 340 sets reference parallax d used for parallax image correction (see FIG. 5 and FIG. 6). Here, it is assumed that the number of horizontal pixels of a parallax image and the number of parallax pixel and reference point of a reference image at each time are attached to an image stream acquired by parallax image acquisition section 310. Reference parallax setting section 340 sequentially acquires the number of horizontal pixels of a parallax image, the number of parallax pixel, and a reference point (these items of information hereinafter being referred to as “image information”) from an image stream input from parallax image acquisition section 310, and outputs this image information to image correction section 370.

Glasses baseline length acquisition section 350 acquires glasses, baseline length e (see FIG. 5 and FIG. 6), and outputs acquired glasses baseline length e to image correction section 370. Glasses baseline length acquisition section 350 may receive a glasses baseline length e setting from a user, for example. Alternatively, glasses baseline length acquisition section 350 may acquire a fixed value decided upon beforehand as a general value—such as the average eye spacing of the citizens of a particular country—as glasses baseline length e. Here, it is assumed that glasses baseline length acquisition section 350 acquires a fixed value as glasses baseline length e.

Display actual width acquisition section 360 acquires display actual width W (see FIG. 5), and outputs acquired display actual width W to image correction section 370. Display actual width acquisition section 360 may, for example, acquire a preset fixed value as display actual width W. Alternatively, display actual width acquisition section 360 may, for example, store a table that associates a display model with a display actual width beforehand, and use this table to acquire corresponding display actual width W from information indicating the 3D image display apparatus 300 model. Here, it is assumed that display actual width acquisition section 360 acquires a fixed value as display actual width W.

When glasses information input from glasses information acquisition section 320 satisfies an appropriate viewing condition input from appropriate viewing condition setting section 330, image correction section 370 outputs an image stream input from parallax image acquisition section 310 to display section 380 without performing correction. At this time, image correction section 370 outputs left-eye image data and right-eye image data to display section 380 while performing switching on a frame-by-frame basis.

On the other hand, when glasses information does not satisfy an appropriate viewing condition, image correction section 370 corrects an image stream so as to enable the viewer to view a 3D image before outputting the image stream. Here, it is assumed that image correction section 370 performs correction of the size and the location only for the right-eye image. Details of this correction will be given later herein.

Image correction section 370 also generates a synchronization signal for switching the light transmission state of the left and right lenses of glasses 500 in accordance with the timing of switching of left-eye image and right-eye image output to display section 380. The synchronization signal directs glasses 500 to place the left lens in a light transmission state and the right lens in a light exclusion state when a left-eye image is being displayed on display section 380. And the synchronization signal directs glasses 500 to place the right lens in a light transmission state and the left lens in a tight exclusion state when a right-eye image is being displayed on display section 380.

Display section 380 displays a left-eye image and right-eye image of an image stream input from image correction section 370 on screen 600 (see FIG. 4 through FIG. 6).

Glasses control section 390 transmits a synchronization signal input from image correction section 370 to glasses 500 by means of UWB communication.

Although not illustrated, 3D image display apparatus 300 can be implemented by means of a CPU (Central Processing Unit), a storage medium such as ROM (Read Only Memory) that stores a control program, working memory such as RAM (Random Access Memory), a communication circuit, and so forth. In this case, the functions of the above sections are implemented by execution of the control program by the CPU.

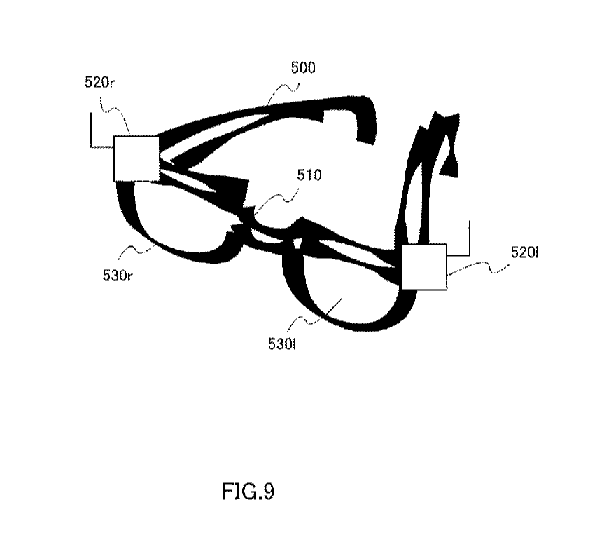

FIG. 9 is an external view of an example of the configuration of 3D viewing glasses 500.

In FIG. 9, glasses 500 have frame 510, left communication section 520l, right communication section 520r, left lens 530l, and right lens 530r. Left communication section 520l, right communication section 520r, left lens 530l, and right lens 530r are all fixed to frame 510 in predetermined positional relationships. Therefore, it is possible to find left lens position Pl and right lens position Pr from the position of left communication section 520l, the position of right communication section 520r, and glasses baseline length e (a fixed value).

Left communication section 520l performs UWB communication with 3D image display apparatus 300. Left communication section 520l performs response processing necessary for glasses information calculation. Left communication section 520l also outputs a synchronization signal received from 3D image display apparatus 300 to left lens 530l.

Right communication section 520r performs UWB communication with 3D image display apparatus 300. Right communication section 520r performs response processing necessary for glasses information calculation. Right communication section 520r also outputs a synchronization signal received from 3D image display apparatus 300 to right lens 530r.

Left lens 530l is a lens positioned in front of the left eye of a viewer, and is provided with a liquid crystal shutter. The liquid crystal shutter switches the light transmission state at high speed in accordance with a synchronization signal input from left communication section 520l.

Right lens 530r is a lens positioned in front of the right eye of a viewer, and is provided with a liquid crystal shutter. The liquid crystal shutter switches the light transmission state at high speed in accordance with a synchronization signal input from right communication section 520r.

3D image display system 100 configured in this way can display a 3D image based on a parallax-image image stream. Also, 3D image display system 100 displays an image stream appropriately corrected so as to enable a viewer to view a 3D image. By this means, a viewer can view a 3D image even when glasses position P and glasses inclination angle θ do not satisfy an original appropriate viewing condition.

The operation of 3D image display apparatus 300 will now be described.

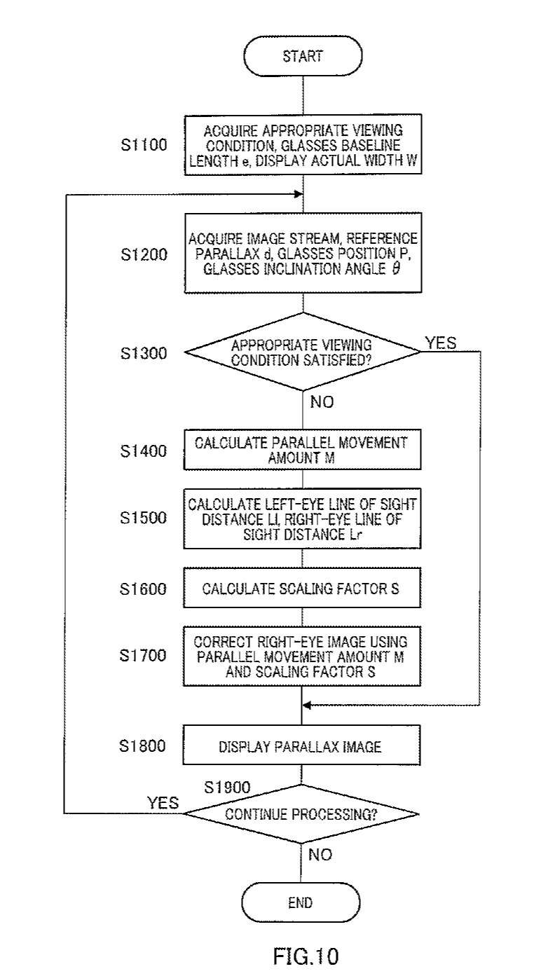

FIG. 10 is a flowchart showing an example of the operation of 3D image display apparatus 300.

First, in step S1100, image correction section 370 acquires an appropriate viewing condition, glasses baseline length e, and display actual width W respectively from appropriate viewing condition setting section 330, glasses baseline length acquisition section 350, and display actual width acquisition section 360.

More specifically, appropriate viewing condition setting section 330 outputs a previously stored fixed value to image correction section 370 as an appropriate viewing condition. Glasses baseline length acquisition section 350 outputs a previously stored fixed value to image correction section 370 as glasses baseline length e. Display actual width acquisition section 360 outputs a previously stored fixed value to image correction section 370 as display actual width W.

In step S1200, image correction section 370 acquires a predetermined number of frames (for example, one frame) of an image stream, image information, and glasses information respectively from parallax image acquisition section 310, reference parallax setting section 340, and glasses information acquisition section 320. Image information includes the number of horizontal pixels, the number of parallax pixel, and reference point. Glasses information includes glasses position P, left lens position Pl, right lens position Pr, and glasses inclination angle θ.

However, it is possible to specify all of glasses position P, left lens position Pl, and right lens position Pr, from glasses baseline length e and glasses inclination angle θ, and any one of glasses position P, left lens position Pl, or right lens position Pr. Therefore, provision may also be made for glasses information to include glasses inclination angle θ and any one of glasses position P, left lens position Pl, or right lens position Pr.

Here, an example is described in which image correction section 370 acquires reference parallax d from display actual width W and the number of horizontal pixels and the number of parallax pixel of an image stream. Also, it is assumed here that it is possible for image correction section 370 to obtain reference parallax d from an image stream, as described above.

More specifically, parallax image acquisition section 310 and reference parallax setting section 340 output an image stream and image information respectively to image correction section 370 in frame units. Then image correction section 370 calculates reference parallax d by dividing the number of parallax pixel by screen resolution R. Alternatively, image correction section 370 may calculate reference parallax d by multiplying a value obtained by dividing display actual width W by the number of horizontal pixels of the image stream by the number of parallax pixel.

Also, image correction section 370 acquires glasses information generated by glasses information acquisition section 320 sequentially, periodically, or as necessary (here, every above predetermined number of frames), for example. Glasses information is assumed to include glasses position P, left lens position Pl, right lens position Pr, and glasses inclination angle θ.

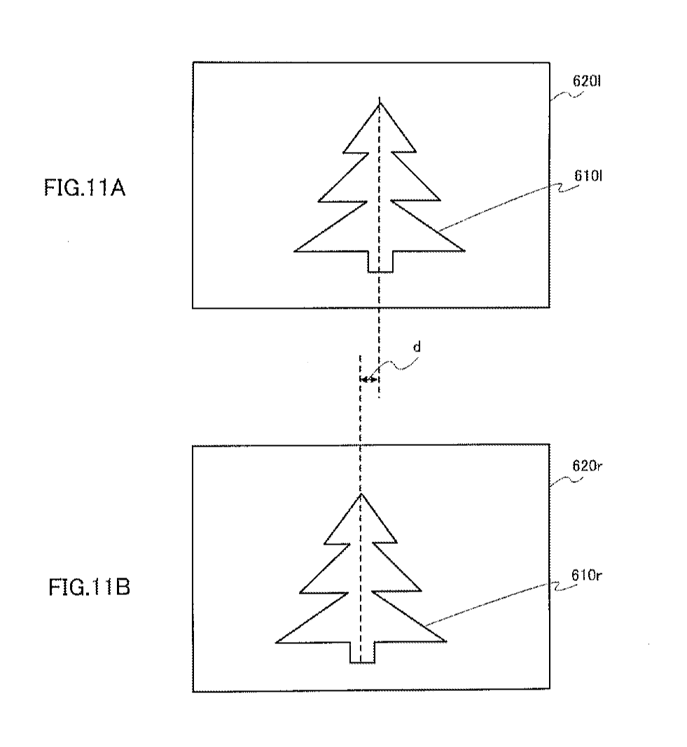

FIG. 11 is a drawing showing an example of an input image stream parallax image. FIG. 11A shows a left-eye image, and FIG. 11B shows a right-eye image.

When an image stream is not corrected, left-eye reference image 610l and right-eye reference image 610r are displayed displaced in the lateral direction (horizontal direction) of screen 600. The amount of this displacement is parallax image reference parallax d.

Then, in step S1300 in FIG. 10, image correction section 370 determines whether or not glasses information satisfies an appropriate viewing condition. That is to say, image correction section 370 determines whether or not glasses position P and glasses inclination angle θ are within an appropriate viewing range (see FIG. 7). This determination determines whether or not a viewer can view a 3D image comfortably without correction being performed. If glasses information satisfies an appropriate viewing condition ( S1300: YES), image correction section 370 proceeds to step S1800 described later herein. If glasses information does not satisfy an appropriate viewing condition (S1300: NO), image correction section 370 proceeds to step S1400.

In step S1400, image correction section 370 calculates right-eye image parallel movement amount M (xm, ym, zm). Parallel movement amount M is the movement amount of right-eye image necessary to solve the inclination problem. That is, parallel movement amount M is a displacement amount such that image parallax is the same as reference parallax d, and angle φ (hereinafter referred to as “image inclination angle φ”) between the image baseline direction and the horizontal plane becomes the same as glasses inclination angle θ.

More specifically, image correction section 370 acquires glasses inclination angle θ acquired in step S1200 as image inclination angle φ. Then image correction section 370 calculates parallel movement amount M (xm, ym, zm) from image inclination angle φ and glasses position P (x, y, z) using equations 3 through 5 below, for example.

[3]

xm=x cos φ (Equation 3)

[4]

ym=−y sin φ (Equation 4)

[5]

zm=0 (Equation 5)

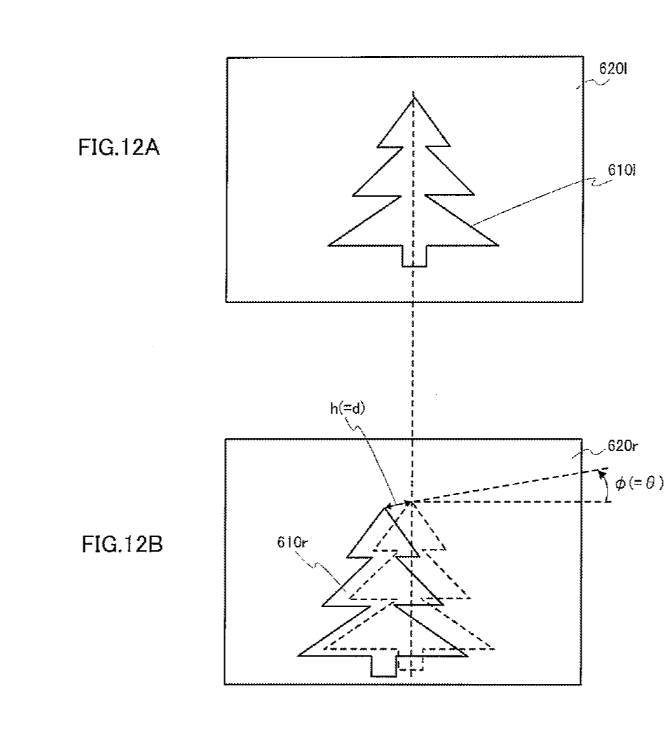

FIG. 12 is a drawing for explaining parallel movement processing, and corresponds to FIG. 11.

As shown in FIG. 12, image parallax h between left-eye reference image 610l and right-eye reference image 610r is a value that is the same as reference parallax d (see FIG. 6). Also, image inclination angle φ corresponding to parallel movement amount M is a value that is the same as glasses inclination angle θ (see FIG. 6). Consequently, a viewer can view reference images 610 in a state in which the glasses baseline direction and image baseline direction coincide even if the viewer's face is inclined relative to screen 600. Therefore, when recognizing stereoscopic vision, a viewer can obtain a natural overlap of left-eye reference image 610l and right-eye reference image 610r.

Then, in step S1500, image correction section 370 calculates left-eye line of sight distance Ll and right-eye line of sight distance Lr (see FIG. 5 for both), based on glasses baseline length e, reference parallax d, left lens position Pl, right lens position Pr, and glasses inclination angle θ.

More specifically, image correction section 370 calculates left-eye line of sight distance Ll and right-eye line of sight distance Lr using equations 6 and 7 below, for example. Here, displacement in the y-axis direction is ignored in order to simplify the processing. Also, in a basic parallax image the xz coordinates of reference point P0l of left-eye reference image 610l are here represented by (xdl, zdl). And in a basic parallax image the xz coordinates of reference point P0r of right-eye reference image 610r are represented by (xdr, zdr).

$$\begin{matrix}( Equation 6 ) & \\ \begin{matrix}Ll = \sqrt{{( xl - xdl )}^{2} + {( zl - zdl )}^{2}} \\ = \sqrt{{\{ ( x - \frac{e cos θ}{2} ) - \frac{d cos φ}{2} \}}^{2} + {( z - 0 )}^{2}} \\ = \sqrt{{( x - \frac{e cos θ}{2} - \frac{d cos θ}{2} )}^{2} + {z}^{2}}\end{matrix} & [ 6 ] \\ ( Equation 7 ) & \\ \begin{matrix}Lr = \sqrt{{( xr - xdr )}^{2} + {( zr - zdr )}^{2}} \\ = \sqrt{{\{ ( x + \frac{e cos θ}{2} ) + \frac{d cos φ}{2} \}}^{2} + {( z - 0 )}^{2}} \\ = \sqrt{{( x + \frac{e cos θ}{2} + \frac{d cos θ}{2} )}^{2} + {z}^{2}}\end{matrix} & [ 7 ]\end{matrix}$$

If the glasses baseline direction is not parallel to screen 600, image correction section 370 may calculate left-eye line of sight distance Ll and right-eye line of sight distance Lr using equations 8 and 9 below, for example.

$$\begin{matrix}( Equation 8 ) & \\ \begin{matrix}Ll = \sqrt{{( xl - xdl )}^{2} + {( zl - zdl )}^{2}} \\ = \sqrt{{( xl - \frac{d cos φ}{2} )}^{2} + {( zl - 0 )}^{2}} \\ = \sqrt{{( xl - \frac{d cos θ}{2} )}^{2} + {zl}^{2}}\end{matrix} & [ 8 ] \\ ( Equation 9 ) & \\ \begin{matrix}Lr = \sqrt{{( xr - xdr )}^{2} + {( zr - zdr )}^{2}} \\ = \sqrt{{\{ xr - ( - \frac{d cos φ}{2} ) \}}^{2} + {( zr - 0 )}^{2}} \\ = \sqrt{{( xr + \frac{d cos θ}{2} )}^{2} + {zr}^{2}}\end{matrix} & [ 9 ]\end{matrix}$$

Then, in step S1600, image correction section 370 calculates right-eye image scaling (enlargement/reduction) factor S, based on left-eye line of sight distance Ll and right-eye line of sight distance Lr. Scaling factor S is a right-eye image scaling factor necessary for solving the diagonal position problem. That is to say, scaling factor S is a scaling factor such that an image size difference after scaling is virtually zero.

More specifically, image correction section 370 calculates scaling factor S using equation 10 below, for example.

$$\begin{matrix}( Equation 10 ) & \\ S = \frac{1}{D} = \frac{Lr}{Ll} & [ 10 ]\end{matrix}$$

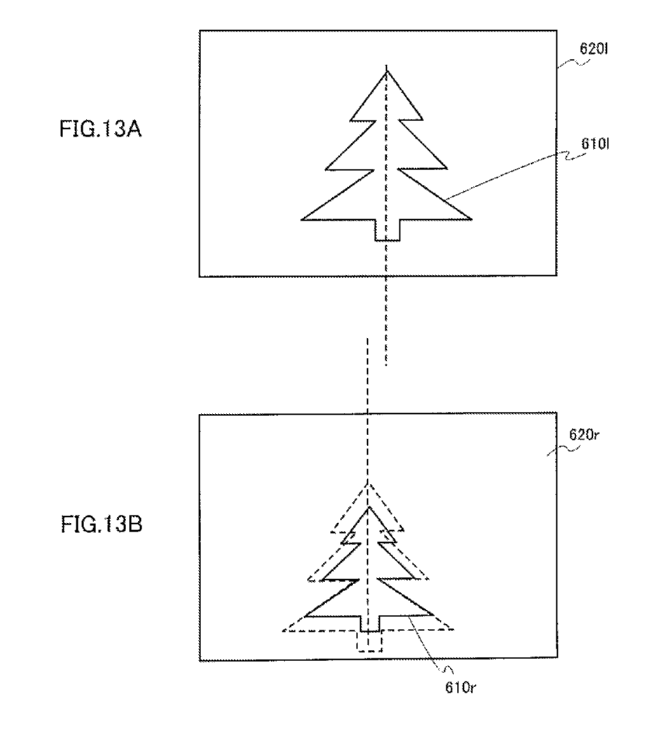

FIG. 13 is a drawing for explaining scaling processing, and corresponds to FIG. 11.

As shown in FIG. 13, the actual size ratio of right-eye reference image 610r with respect to left-eye reference image 610l on screen 600 is virtually identical to calculated scaling factor S. Also, the size of right-eye reference image 610r that can be viewed with a viewer's right eye is virtually the same as the size of left-eye reference image 610l that can be viewed with the viewer's left eye. That is to say, the image size difference is virtually zero. Consequently, a viewer can view reference images 610 at the same size with the right eye and left eye, even from a position diagonal to screen 600. Therefore, when recognizing stereoscopic vision, a viewer can obtain a natural overlap of left-eye reference image 610l and right-eye reference image 610r.

Then, in step S1700 in FIG. 10, image correction section 370 performs correction so that a right-eye image in an input image stream is moved by parallel movement amount M, and scaled by scaling factor S, relative to a left-eye image. Image correction section 370 performs scaling with right-eye image reference point P0r (a point corresponding to a left-eye image reference point) as a fixed point, for example.

In parallel movement processing and scaling processing, image correction section 370 may also directly correct a relative position and relative size with respect to the screen 600 frame for a right-eye image. Also, parallel movement processing and scaling processing may also be processing that causes display section 380 to change the display position and display size of a right-eye image in screen 600. When causing display section 380 to change the display position and display size, image correction section 370 corrects display position and display size related parameters attached to the image stream, for example.

Then, in step S1800, image correction section 370 outputs the image stream to display section 380 in frame units, and displays a parallax image on screen 600. As a result, a left-eye image and right-eye image are displayed switched at high speed by display section 380. In this case, when correcting the right-eye image, image correction section 370 outputs the corrected right-eye image by replacing the input right-eye image. At this time, glasses control section 390 operates glasses 500 in synchronization with the parallax image, by transmitting a synchronization signal input from image correction section 370 to glasses 500 as described above.

Then, in step S1900, image correction section 370 determines whether or not parallax image display processing is to be continued. For example, image correction section 370 determines to continue processing while image stream input continues, and determines not to continue processing when image stream input ends. Image correction section 370 returns to step S1200 if processing is to be continued (S1900: YES), or terminates the series of processing steps if processing is not to be continued (S1900: NO).

By means of such operation, 3D image display apparatus 300 displays a parallax image corrected so as to enable a viewer to view a 3D image in accordance with the viewer's position or facial inclination, enabling the diagonal position problem and inclination problem to be lessened. Also, since correction is performed in a state in which image parallax that is the same as reference parallax is maintained, a reference image can be displayed with a sense of depth intended by the image creator.

As described above, a 3D image display system according to the present embodiment performs size and position correction for a parallax image so as to enable to view a 3D image in accordance with a viewer's position and facial inclination. By this means, a viewer can view a 3D image in a state in which the diagonal position problem and inclination problem have been lessened.

Also, the above correction requires only simple processing that is parallel movement and scaling processing on a right-eye image. Consequently, a 3D image display system according to the present embodiment enables the diagonal position problem and inclination problem to be lessened easily, even in the case of an image stream of 3D image content.

Furthermore, the above correction does not distort a reference image with respect to the display frame. Consequently, a 3D image display system according to the present embodiment gives a viewer the same kind of feeling as when viewing a display displaying a conventional 2D image.

That is to say, using a 3D image display system according to the present embodiment enables a viewer to more comfortably view a 3D image using a previously created image stream for 3D viewing.

Provision may also be made for a 3D image display system to perform only either parallel movement processing or scaling processing. Also, a 3D image display system need not acquire a glasses position when scaling processing is not performed, and need not acquire a glasses inclination angle when parallel movement processing is not performed.

Moreover, instead of determining whether or not an appropriate viewing condition is satisfied, a 3D image display system may always perform parallel movement amount and scaling factor calculation, and perform parallel movement processing and scaling processing according to the calculation results.

Also, a 3D image display system need not necessarily make an image inclination angle zero, but may perform parallel movement processing such that an appropriate viewing condition is satisfied (that is, such that an image inclination angle satisfies an appropriate viewing condition) in a post-correction image stream. In this case, the 3D image display system may, for example, use a table in which, for each glasses inclination angle level classified into widths less than an appropriate viewing range width, a parallel movement direction is associated on a level-by-level basis. By this means, parallel movement amount calculation processing can be eliminated, enabling parallel movement processing to be speeded up.

Furthermore, a 3D image display system need not necessarily make an image size difference zero, but may perform scaling processing such that an appropriate viewing condition is satisfied (that is, such that an image size difference satisfies an appropriate viewing condition) in a post-correction image stream. In this case, the 3D image display system may, for example, use a table in which, for each level of a ratio of left eye line of sight distance to right eye line of sight distance classified into widths less than an appropriate viewing range width, a scaling factor is associated on a level-by-level basis. By this means, scaling factor calculation processing can be eliminated, enabling scaling processing to be speeded up.

Moreover, a 3D image display system may correct only a left-eye image with a right-eye image as a reference, or may correct both a right-eye image and a left-eye image. If both are corrected, a reference image can be displayed at a size closer to the size intended by the image creator.

Also, a 3D image display system may make an appropriate viewing condition, glasses baseline length, and display actual width, variable values.' Furthermore, a 3D image display system may make reference parallax a fixed value.

Moreover, if a 3D image display system does not take the inclination problem into consideration, it is not necessary to acquire a glasses inclination angle, and therefore glasses 500 may be provided with only one UWB antenna. If the UWB antenna is fixed in the center of the glasses, glasses position acquisition becomes easier.

Also, a 3D image display system may perform glasses 500 control and glasses information acquisition using a means other than UWB communication, such as infrared communication.

### Embodiment 2

Embodiment 2 of the present invention is an example in which switching to 2D image display is performed when an appropriate viewing condition is not satisfied.

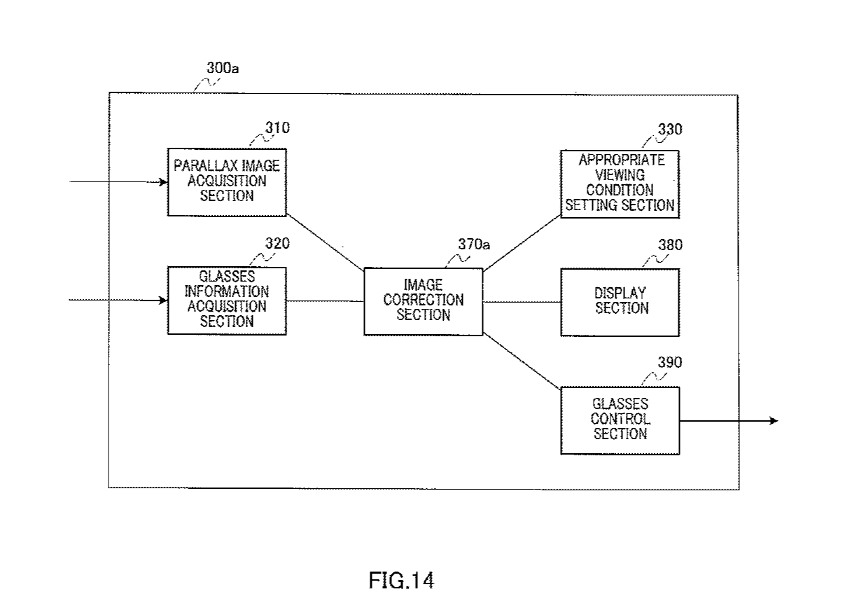

FIG. 14 is a block diagram showing an example of the configuration of a 3D image display apparatus according to the present embodiment, and corresponds to FIG. 8 of Embodiment 1. Parts in FIG. 14 identical to those in FIG. 8 are assigned the same reference codes as in FIG. 8, and descriptions thereof will be omitted.

Unlike in FIG. 8, 3D image display apparatus 300a in FIG. 14 does not have a reference parallax setting section, glasses baseline length acquisition section, or display actual width acquisition section. Also, 3D image display apparatus 300a has image correction section 370a that executes different processing from that of the image correction section in FIG. 8.

When glasses information does not satisfy an appropriate viewing condition, image correction section 370a stops right-eye image display, and replaces right-eye image data with left-eye image data of the same frame. That is to say, when the diagonal position problem and inclination problem may occur, image correction section 370a continues displaying only a left-eye image and switches to 2D image display, for example.

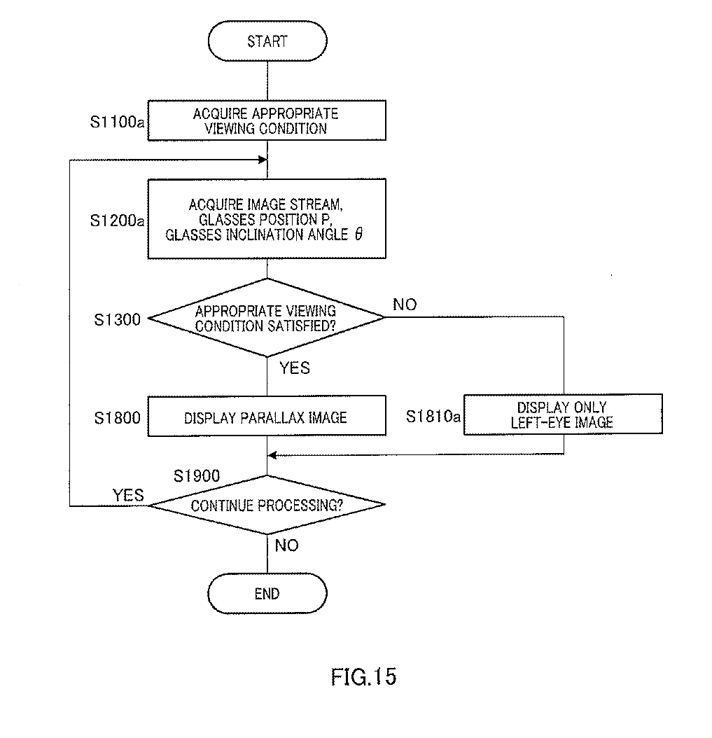

FIG. 15 is a flowchart showing an example of the operation of 3D image display apparatus 300a, and corresponds to FIG. 10 of Embodiment 1. Parts in FIG. 15 identical to those in FIG. 10 are assigned the same step numbers as in FIG. 10, and descriptions thereof will be omitted.

First, in step S1100a, image correction section 370a acquires an appropriate viewing condition from appropriate viewing condition setting section 330.

In step S1200a, image correction section 370a acquires an image stream and glasses information respectively from parallax image acquisition section 310 and glasses information acquisition section 320. Glasses information includes glasses position P, left lens position Pl, right lens position Pr, and glasses inclination angle θ, as described above.

Then, if glasses information satisfies an appropriate viewing condition (S1300: YES), image correction section 370a proceeds to step S1800. As a result, image correction section 370a outputs an image stream input from parallax image acquisition section 310 directly to display section 380. That is to say, image correction section 370a causes a parallax image to be displayed on screen 600 in the usual way.

On the other hand, if glasses information does not satisfy an appropriate viewing condition (S1300: NO), image correction section 370a proceeds to step S1810a.

In step S1810a, image correction section 370a replaces right-eye image data with left-eye image data of the same frame. By this means, image correction section 370a outputs an image stream comprising only a left-eye image to display section 380, and causes only a left-eye image to be displayed. As a result, a 2D image is displayed on screen 600, and a state is established in which the diagonal position problem and inclination problem specific to a 3D image cannot occur. Image correction section 370a then proceeds to step S1900.

Thus, a 3D image display system according to the present embodiment can avoid the diagonal position problem and inclination problem while displaying a 3D image as far as possible, without performing parallel movement or scaling processing on an image. Therefore, a 3D image display system according to the present embodiment enables to reduce the processing load and to simplify the apparatus configuration as compared with Embodiment 1.

Also, since right-eye image display is not simply stopped, switching to 2D image display can be performed in a state in which image brightness is maintained, and any feeling of unnaturalness or discomfort imparted to a viewer when switching is performed can be reduced.

A 3D image display system according to the present embodiment may be combined with Embodiment 1, and switching between image correction and 2D image display may be performed as necessary. For example, it is desirable to switch to 2D image display if the viewer is too close to the screen, for instance, and the image sizes of image parts other than a reference image do not match, or there are significant losses of the right-eye image.

### Embodiment 3

Embodiment 3 of the present invention is an example in which notification is given when an appropriate viewing condition is not satisfied or when a state is entered in which glasses information seems likely to deviate from an appropriate viewing condition.

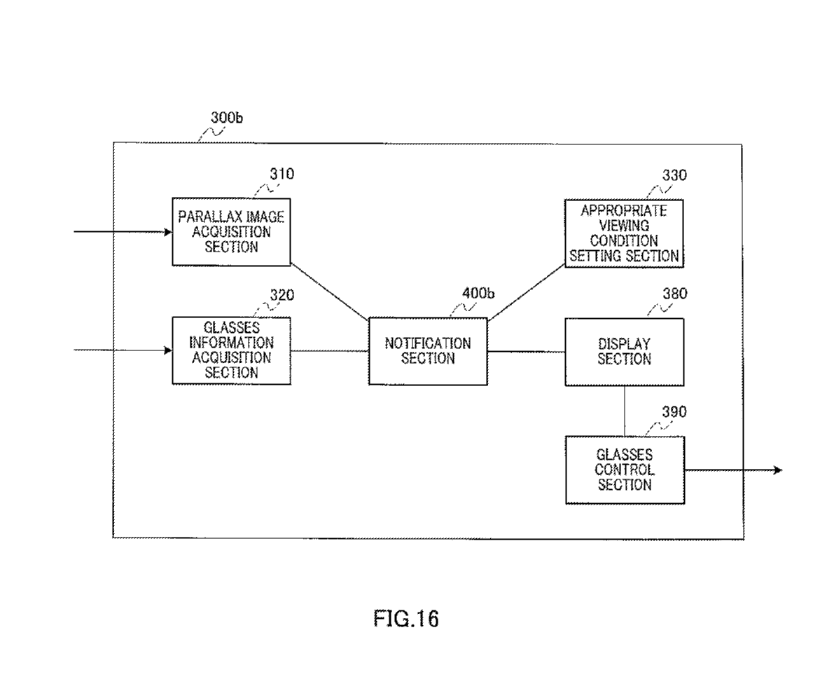

FIG. 16 is a block diagram showing an example of the configuration of a 3D image display apparatus according to the present embodiment, and corresponds to FIG. 14 of Embodiment 2. Parts in FIG. 16 identical to those in FIG. 14 are assigned the same reference codes as in FIG. 14, and descriptions thereof will be omitted.

In FIG. 16, 3D image display apparatus 300b has notification section 400b instead of an image correction section.

Notification section 400b does not perform correction on an image, but when glasses information does not satisfy an appropriate viewing condition or when a state is entered in which glasses information seems likely to deviate from an appropriate viewing condition, issues a predetermined notification indicating this fact. A state in which glasses information seems likely to deviate from an appropriate viewing condition is, for example, a state in which glasses 500 are in a position close to a position at a boundary between being within a glasses appropriate viewing range and being outside the appropriate viewing range. Also, a state in which glasses information seems likely to deviate from an appropriate viewing condition is, for example, a state of inclination at an angle at the boundary between being within a glasses appropriate viewing range and being outside the appropriate viewing range. In the present embodiment, a state in which glasses information seems likely to deviate from an appropriate viewing condition is assumed below to be included in a state in which glasses information does not satisfy an appropriate viewing condition,

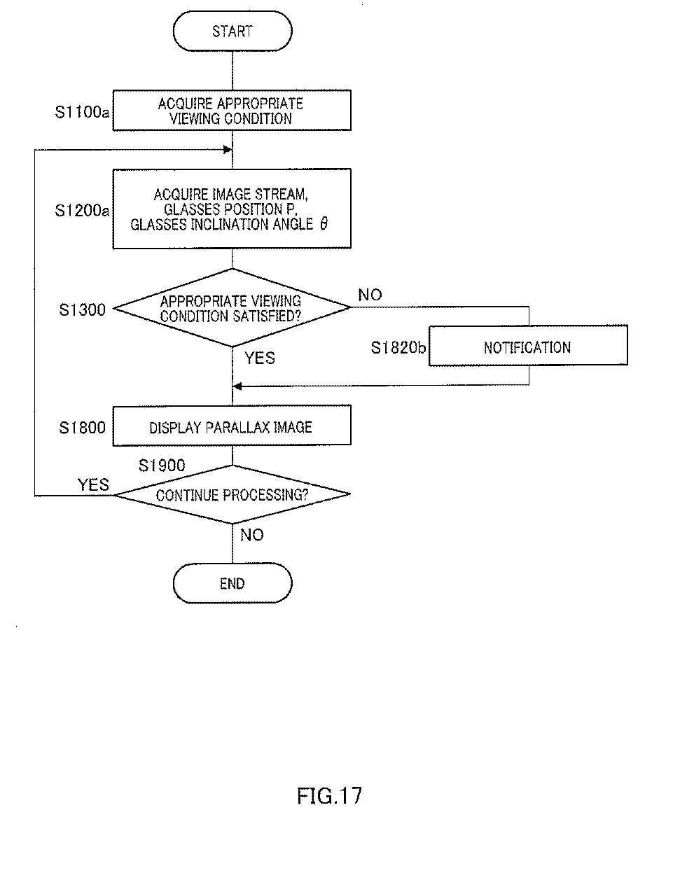

FIG. 17 is a flowchart showing an example of the operation of 3D image display apparatus 300b, and corresponds to FIG. 15 of Embodiment 2. Parts in FIG. 17 identical to those in FIG. 15 are assigned the same step numbers as in FIG. 15, and descriptions thereof will be omitted. Also, of the processing executed by the image correction section in Embodiment 2, processing also executed in the present embodiment is assumed to be executed by notification section 400b.

If glasses information satisfies an appropriate viewing condition (S1300: YES), notification section 400b proceeds to step S1800. As a result, notification section 400b outputs an image stream input from parallax image acquisition section 310 directly to display section 380. That is to say, notification section 400b causes a parallax image to be displayed on screen 600 in the usual way.

On the other hand, if glasses information does not satisfy an appropriate viewing condition (S1300: NO), notification section 400b proceeds to step S1820b.

In step S1820b, notification section 400b gives a predetermined notification indicating that glasses information does not satisfy the appropriate viewing condition—that is, indicating that the diagonal position problem and inclination problem has arisen—and then proceeds to step S1800. The predetermined notification is, for example, speech output from a speaker, a text display on screen 600, or the like.

With a simple notification alone, there may be viewers who are unable to determine immediately what should be done to enable a 3D image to be viewed. Therefore, it is desirable for the notification to inform the viewer of what should be done to avoid the diagonal position problem and inclination problem. For example, a message such as “Please move to a position facing the screen more directly” or “Please hold your head in a more upright position” may be output. On receiving a predetermined notification, the viewer can adjust his or her position and facial inclination correctly so as to be able to view a 3D image, and can continue to view a 3D image.

Thus, a 3D image display system according to the present embodiment can avoid the diagonal position problem and inclination problem without performing correction on an image or switching to 2D image display. Therefore, a 3D image display system according to the present embodiment enables to reduce the processing load and to simplify the apparatus configuration as compared with Embodiment 1 and Embodiment 2.

Also, a 3D image display system according to the present embodiment enables to avoid the diagonal position problem and inclination problem with certainty by giving notification when a state is entered in which glasses information seems likely to deviate from an appropriate viewing condition.

A 3D image display system according to the present embodiment may be combined with Embodiment 1, and notification may be given if the viewer is too close to the screen, for instance, and the image sizes of image parts other than a reference image do not match, or there are significant losses of the right-eye image.

Moreover, a 3D image display system according to the present embodiment may be combined with Embodiment 1, and provision may be made for correction processing to be performed if glasses information still does not satisfy an appropriate viewing condition after a certain period has elapsed following notification of the fact that glasses information does not satisfy an appropriate viewing condition.

### Embodiment 4

Embodiment 4 of the present invention is an example in which switching to 2D image display is performed on a viewer-by-viewer basis in order to lessen the multiple viewer problem.

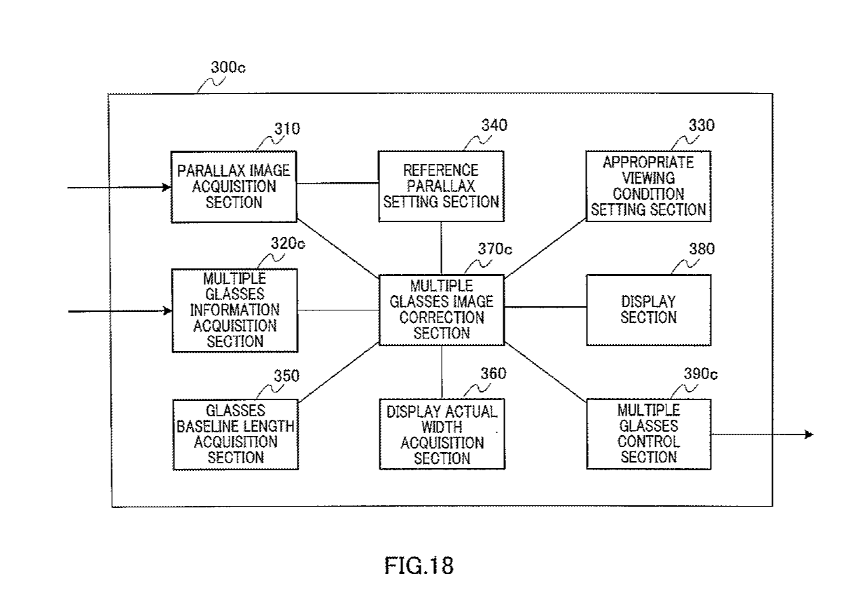

FIG. 18 is a block diagram showing an example of the configuration of a 3D image display apparatus according to the present embodiment, and corresponds to FIG. 8 of Embodiment 1. Parts in FIG. 18 identical to those in FIG. 8 are assigned the same reference codes as in FIG. 8, and descriptions thereof will be omitted. In the present embodiment, it is assumed that a plurality of viewers are wearing glasses 500 and viewing 3D image display apparatus 300c. It is also assumed that identification information has been assigned to each pair of glasses 500 beforehand, and radio communication is possible on an individual basis between each pair of glasses 500 and 3D image display apparatus 300c using this identification information.

3D image display apparatus 300c in FIG. 18 has multiple glasses information acquisition section 320c, multiple glasses image correction section 370c, and multiple glasses control section 390c instead of the glasses information acquisition section, image correction section, and glasses control section in FIG. 8.

Multiple glasses information acquisition section 320c sequentially acquires glasses information from a plurality of glasses 500 on an individual basis, and outputs the acquired glasses information to multiple glasses image correction section 370c. In the present embodiment, glasses information includes corresponding glasses 500 identification information.

Multiple glasses image correction section 370c performs correction on a right-eye image, handling glasses information of the plurality of glasses 500 comprehensively. Also, multiple glasses image correction section 370c performs determination of whether or not an appropriate viewing condition is satisfied for each pair of glasses 500. Then multiple glasses image correction section 370c generates a synchronization signal such that a normal parallax image can be viewed by a viewer who satisfies an appropriate viewing condition, and only a left-eye image can be viewed by a viewer who does not satisfy an appropriate viewing condition. More specifically, multiple glasses image correction section 370c switches the light transmission state for glasses 500 that satisfy an appropriate viewing condition in accordance with a parallax image. And multiple glasses image correction section 370c generates a synchronization signal that causes only a left-eye image to be transmitted (passed through) for glasses 500 that do not satisfy an appropriate viewing condition.

Multiple glasses control section 390c transmits a synchronization signal to each of the plurality of glasses 500.

One method of implementing the above-described operations that differ for each pair of glasses 500 is, for example, to generate two signals corresponding to different operations, and transmit only a corresponding signal to each pair of glasses 500. Another possible method is to add information specifying glasses 500 to which only a left-eye image is to be transmitted to a common signal. In the description of the present embodiment, use of the latter method is assumed.

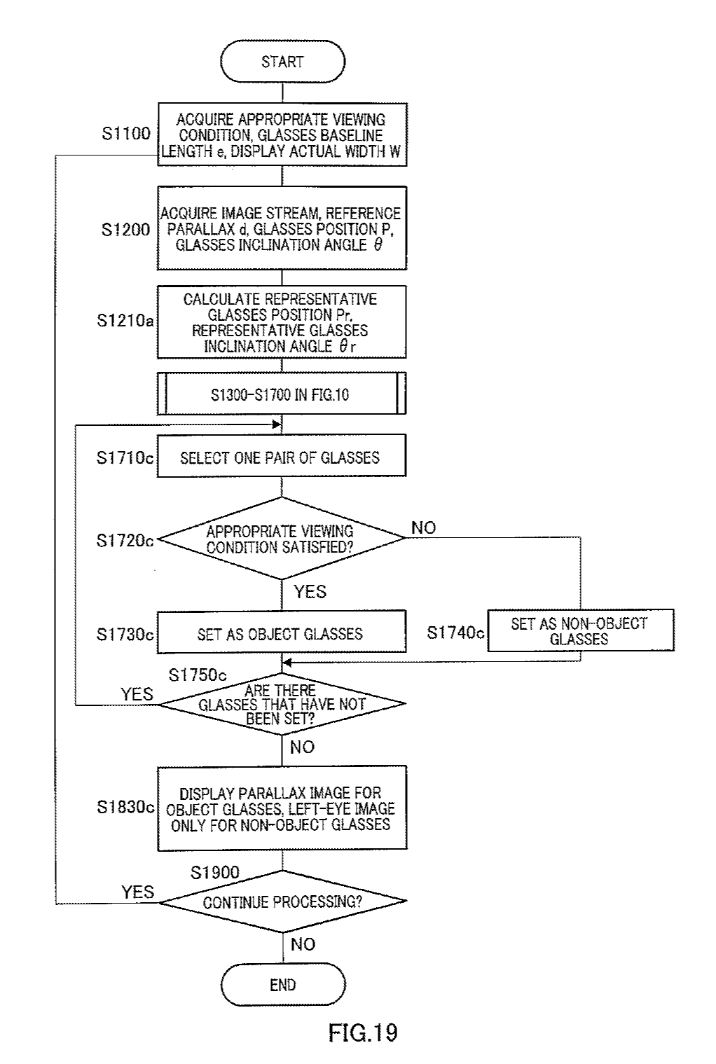

FIG. 19 is a flowchart showing an example of the operation of 3D image display apparatus 300c, and corresponds to FIG. 10 of Embodiment 1.Parts in FIG. 19 identical to those in FIG. 10 are assigned the same step numbers as in FIG. 10, and descriptions thereof will be omitted. Also, of the processing executed by the image correction section in Embodiment 1, processing also executed in the present embodiment is assumed to be executed by multiple glasses image correction section 370c. Symbol i indicates a parameter acquired for each pair of glasses 500 on an individual basis.

After acquiring individual glasses information for a plurality of glasses 500, in step S1210a multiple glasses image correction section 370c calculates representative glasses position Pr and representative glasses inclination angle θr. Glasses information includes glasses position Pi, left lens position Pli, right lens position Pri, and glasses inclination angle θi, as described above. Representative glasses position Pr is a glasses position representing glasses positions Pi of a plurality of glasses 500, and is, for example, a combination of average values of each coordinate axis of glasses positions Pi. Representative glasses inclination angle θr is a glasses inclination angle representing glasses inclination angles θi of a plurality of glasses 500, and is, for example, an average value of glasses inclination angles θi. That is to say, representative glasses position Pr and representative glasses inclination angle θr are a glasses position and glasses inclination angle of virtual glasses 500 representing a plurality of glasses 500.

Then multiple glasses image correction section 370c executes the processing in steps S1300 through S1700 in FIG. 10, based on representative glasses position Pr and representative glasses inclination angle θr. By this means, if representative glasses position Pr and representative glasses inclination angle θr do not satisfy an appropriate viewing condition, correction is performed on a right-eye image in the same way as in Embodiment 1. That is to say, multiple glasses image correction section 370c corrects a right-eye image in accordance with above-described virtual glasses 500.

Then, in step S1710c, multiple glasses image correction section 370c uses identification information included in glasses information to select one pair of glasses 500 from among the plurality of glasses 500.

Then, in step S1720c, multiple glasses image correction section 370c determines whether or not the glasses information of the selected glasses 500 satisfies an appropriate viewing condition in a parallax image that is actually displayed. A parallax image that is actually displayed is a parallax image that is output to display section 380 by multiple glasses image correction section 370c as a result of steps S1300 through S1700, and is actually displayed by display section 380.

Whether or not an appropriate viewing condition is satisfied in a displayed parallax image can be determined, for example, by converting a basic appropriate viewing range (see FIG. 7) in accordance with a displayed parallax image, and determining whether or not glasses information is within the post-conversion appropriate viewing range. The conversion in this case is, for example, conversion such that the normal direction and horizontal direction of screen 600 become the representative glasses position Pr direction and image baseline direction with respect to screen 600.

Alternatively, whether or not an appropriate viewing condition is satisfied in a displayed parallax image can be determined, for example, by determining whether or not equations 11 and 12 below are satisfied.

$$\begin{matrix}( Equation 11 ) & \\ \vert θ i - θ r \vert < θ th & [ 11 ] \\ ( Equation 12 ) & \\ \frac{1}{Dth} \leq Di = \frac{Lli}{Lri} < Dth & [ 12 ]\end{matrix}$$

If glasses information satisfies an appropriate viewing condition (S1720c: YES), multiple glasses image correction section 370c proceeds to step S1730c. On the other hand, If glasses information does not satisfy an appropriate viewing condition (S1720c: NO), multiple glasses image correction section 370c proceeds to step S1740c.

In step S1730c, multiple glasses image correction section 370c sets selected glasses 500 as glasses to be an object of parallax image display (hereinafter referred to as “object glasses”), and proceeds to step S1750c.

On the other hand, in step S1740c, multiple glasses image correction section 370e sets selected glasses 500 as glasses not to be an object of parallax image display (hereinafter referred to as “non-object glasses”), and proceeds to step S1750c.

Then, in step S1750c, multiple glasses image correction section 370c determines whether or not there are glasses 500 that have not been set as either object glasses or non-object glasses. If there are glasses 500 that have not been set (S1750c: YES), multiple glasses image correction section 370c returns to step S1710c. Multiple glasses image correction section 370c then selects glasses 500 that have not been set and repeats the processing. On the other hand, if all glasses 500 have been set as either object glasses or non-object glasses (S1750c: NO), multiple glasses image correction section 370c proceeds to step S1830c.

In step S1830c, multiple glasses image correction section 370c controls each pair of glasses 500 via multiple glasses control section 390c, based on whether they are object glasses or non-object glasses. As a result, glasses 500 set as object glasses are controlled such that a parallax image is displayed. Glasses 500 set as non-object glasses are controlled such that only a left-eye image is displayed.

More specifically, in the same way as in Embodiment 1, multiple glasses image correction section 370c outputs an image stream to display section 380, and outputs a synchronization signal to multiple glasses control section 390c. At this time, if there are glasses 500 that have been set as non-object glasses, multiple glasses image correction section 370c outputs the identification information of those glasses 500 to multiple glasses control section 390c as non-object information.

Multiple glasses control section 390c transmits non-object information to each pair of glasses 500 together with a synchronization signal.

When identification information of a pair of glasses 500 is included in a received synchronization signal as non-object information, left lens 530l and right lens 530r of that pair of glasses 500 switch their light transmission states so that only a left-eye image is transmitted.

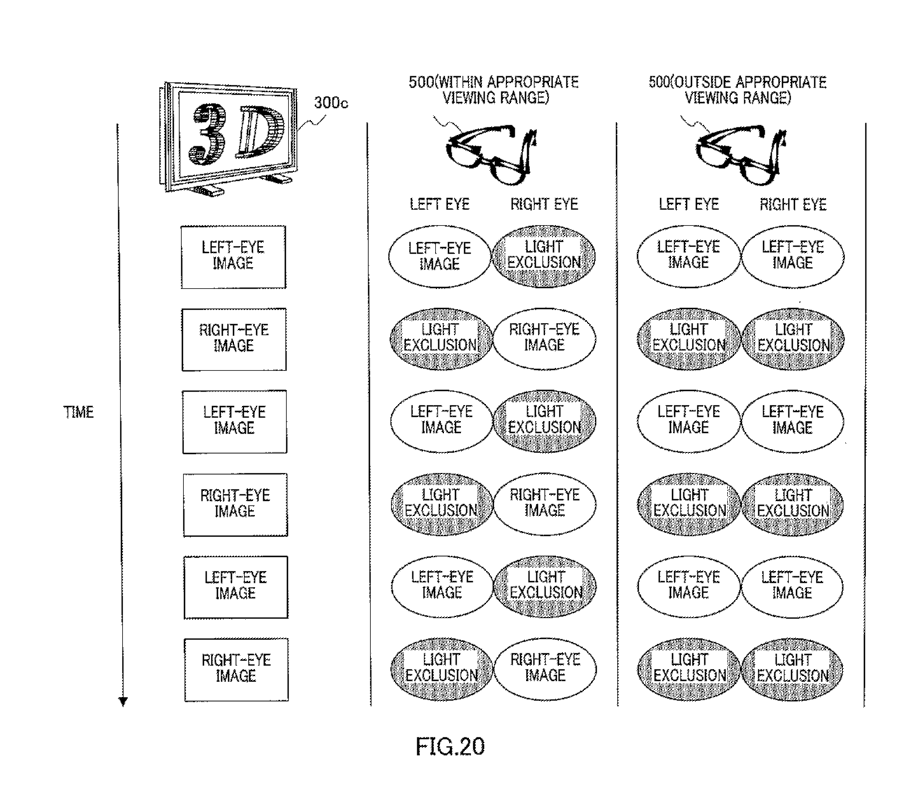

FIG. 20 is a drawing showing an example of the nature of glasses 500 control in the present embodiment. In FIG. 20, the vertical axis indicates time, the column on the left indicates display image states of 3D image display apparatus 300c. And the center column indicates the states of images reaching the left and right eyes of a viewer wearing glasses 500 set as object glasses, and the column on the right indicates the states of images reaching the left and right eyes of a viewer wearing glasses 500 set as non-object glasses.

As shown in FIG. 20, a left-eye image and right-eye image are displayed alternately on 3D image display apparatus 300c. Glasses 500 set as object glasses make only left lens 530l transmissive while a left-eye image is being displayed, in accordance with a synchronization signal. Also, glasses 500 set as object glasses make only right lens 530r transmissive while a right-eye image is being displayed, in accordance with a synchronization signal. By this means, a viewer wearing glasses 500 set as object glasses views only a left-eye image with the left eye, and only a right-eye image with the right eye.

Glasses 500 set as object glasses are glasses 500 that satisfy an appropriate viewing condition in a displayed parallax image. Therefore, a viewer wearing these glasses 500 can view an image stream as a 3D image.

On the other hand, glasses 500 set as non-object glasses make both left lens 530l and right lens 530r transmissive while a left-eye image is being displayed. Also, glasses 500 set as non-object glasses make both left lens 530l and right lens 530r non-transmissive (light-excluding) while a right-eye image is being displayed. By this means, a viewer wearing glasses 500 set as non-object glasses views only a left-eye image with both eyes.

Glasses 500 set as non-object glasses are glasses 500 that do not satisfy an appropriate viewing condition in a displayed parallax image. Therefore, a viewer wearing glasses 500 set as non-object glasses, although viewing only a left-eye image with the left eye and viewing only a right-eye image with the right eye, cannot view a 3D image due to the diagonal position problem and inclination problem. Therefore, a 2D-image image stream is actually more comfortable to view for such a viewer. Thus, in the present embodiment, an image stream is displayed as a 2D image for such a viewer.

Thus, a 3D image display system according to the present embodiment can easily perform image correction that takes a plurality of viewers into consideration by using a representative glasses position and representative glasses inclination angle.

Also, when it is difficult for an appropriate viewing condition to be satisfied by all of a plurality of viewers, a 3D image display system according to the present embodiment switches display to a 2D image as necessary on an individual basis, and displays a 3D image as far as possible. By this means, a 3D image display system according to the present embodiment enables to avoid the diagonal position problem and inclination problem, and to lessen the multiple viewer problem.

Furthermore, a 3D image display system according to the present embodiment controls operation on the glasses side on an individual basis, enabling to easily perform display control for each pair of glasses.

The appropriateness of image correction that takes a plurality of viewers into consideration differs according to the usage environment. Therefore, the methods of deciding a representative glasses position and representative glasses inclination angle are not limited to the methods described above, and it is desirable to use methods suited to the usage environment. For example, in a case in which a large number of viewers are assumed to be in fixed positions, it is desirable for a 3D image display system to exclude glasses at a great distance from other glasses from an average value calculation. Also, in a case in which a large number of viewers are assumed to have their faces inclined at a similar angle, it is desirable to exclude glasses with a large difference in glasses inclination angle compared with other glasses from an average value calculation.

Also, if glasses that do not satisfy an appropriate viewing condition in a parallax image that is actually displayed are of a certain number or above or account for a certain proportion or above, a 3D image display system may switch to 2D image display as in Embodiment 2. In this case, it is no longer necessary to control operation on the glasses side on an individual basis, and it is possible to reduce the processing load and simplify the apparatus configuration.

Furthermore, if glasses that do not satisfy an appropriate viewing condition in a parallax image that is actually displayed account for at least one pair, or are of a certain number or above or account for a certain proportion or above, a 3D image display system may give a predetermined notification as in Embodiment 3. In this case, the 3D image display system may operate a vibrator, speaker, light emitting device, or the like, provided on the glasses, for example, in order to make clear which glasses the notification is for.

In these embodiments, examples have been described in which a 3D image display apparatus is provided in a television, but a 3D image display apparatus may also be provided in image playback apparatus 200 or another apparatus. In this case, it is necessary for the 3D image display apparatus to acquire the position of a reference point of a left-eye reference image and the position of a reference point of a right-eye reference image displayed on the television, together with glasses information.

In these embodiments, examples have been described in which the present invention is applied to a liquid crystal shutter type of 3D image display system. In addition to this, the present invention can be applied to a color filter type of 3D image display system, a polarization filter type of 3D image display system, or various other kinds of 3D image display systems.

The disclosure of Japanese Patent Application No. 2009-223029, filed on Sep. 28, 2009, including the specification, drawings and abstract, is incorporated herein by reference in its entirety.

### INDUSTRIAL APPLICABILITY

A 3D image display apparatus and 3D image display method according to the present invention are suitable for use as a 3D image display apparatus and 3D image display method that enable a viewer to view more comfortably a 3D image using an image stream for 3D viewing. More specifically, the present invention is suitable for use in, for example, an image device of a type that obtains a 3D image using glasses among image devices such as home televisions, Blu-ray disc. (registered trademark) playback apparatuses, and so forth. Also, the present invention is suitable for use in, for example, an image device used in a facility that provides 3D images to customers in a similar way, among public image provision facilities (mini theaters, sports image provision facilities, and so forth).

### REFERENCE SIGNS LIST

100 3D image display system
200 Image playback apparatus
300, 300a, 300b, 300c 3D image display apparatus
310 Parallax image acquisition section
320 Glasses information acquisition section
320c Multiple glasses information acquisition section
330 Appropriate viewing condition setting section
340 Reference parallax setting section
350 Glasses baseline length acquisition section
360 Display actual width acquisition section
370, 370a Image correction section
370c Multiple glasses image correction section
380 Display section
390 Glasses control section
390c Multiple glasses control section
400b Notification section
500 Glasses
510 Frame
520l Left communication section
520r Right communication section
530l Left lens
530r Right lens
600 Screen

1. A three-dimensional ( 3D) image display apparatus that displays a 3D image from an image stream for 3D viewing that includes a left-eye image and a right-eye image, using a screen and 3D viewing glasses, the 3D image display apparatus comprising:
an appropriate viewing condition setting section that sets an appropriate viewing condition under which a viewer wearing the 3D viewing glasses can view a 3D image;
a glasses information acquisition section that acquires, as glasses information, at least one of a position and an inclination of the 3D viewing glasses relative to the screen; and
an image correction section that, when the glasses information does not satisfy the appropriate viewing condition, performs correction of at least one of a size and a position for at least one of the left-eye image and the right-eye image, and outputs an image to the screen.

2. The 3D image display apparatus according to claim 1, wherein the image correction section performs correction that performs parallel movement of at least one of the left-eye image and the right-eye image to a position at which a parallax direction of the left-eye image and the right-eye image in the screen coincides with an inclination direction of the 3D viewing glasses.

3. The 3D image display apparatus according to claim 2, wherein the image correction section performs correction that performs parallel movement of at least one of the left-eye image and the right-eye image to a position at which a parallax of the left-eye image and the right-eye image in the screen is maintained.

4. The 3D image display apparatus according to claim 1, wherein the image correction section performs correction that scales at least one of the left-eye image and the light-eye image with a scaling factor such that a size ratio of an image of the right-eye image with respect to an image of the left-eye image in the screen coincides with a ratio of a distance from a left lens of the 3D viewing glasses to an image of the left-eye image with respect to a distance from a right lens of the 3D viewing glasses to an image of the right-eye image.

5. The 3D image display apparatus according to claim 1, wherein the image correction section, when a plurality of the 3D viewing glasses exist, performs the correction when at least one of a representative position representing positions of the plurality of 3D viewing glasses and a representative inclination representing inclinations of the plurality of 3D viewing glasses does not satisfy the appropriate viewing condition.

6. The 3D image display apparatus according to claim 5, wherein:
the representative position is an average value of positions of the plurality of 3D viewing glasses; and
the representative inclination is an average value of inclinations of the plurality of 3D viewing glasses.

7. The 3D image display apparatus according to claim 1, further comprising a distance calculation section that, when a plurality of the 3D viewing glasses exist for which the glasses information does not satisfy the appropriate viewing condition in an image on which the image correction section has performed correction, controls a display state in the screen of the image stream or a light transmission state of 3D viewing glasses so that a viewer wearing those 3D viewing glasses can view only one of a left-eye image or a right-eye image.

8. A 3D image display apparatus that displays a 3D image from an image stream for 3D viewing that includes a left-eye image and a right-eye image, using a screen and 3D viewing glasses, the 3D image display apparatus comprising:
an appropriate viewing condition setting section that sets an appropriate viewing condition under which a viewer wearing the 3D viewing glasses can view a 3D image;
a glasses information acquisition section that acquires, as glasses information, at least one of a position and an inclination of the 3D viewing glasses relative to the screen; and
a notification section that performs predetermined notification to a viewer wearing the 3D viewing glasses when the glasses information does not satisfy the appropriate viewing condition.

9. A 3D image display method that displays a 3D image from an image stream for 3D viewing that includes a left-eye image and a right-eye image, using a screen and 3D viewing glasses, the 3D image display method comprising:
a step of acquiring, as glasses information, at least one of a position and an inclination of the 3D viewing glasses relative to the screen;
a step of determining whether or not the glasses information satisfies an appropriate viewing condition under which a viewer wearing the 3D viewing glasses can view a 3D image; and
a step of performing predetermined notification to a viewer wearing the 3D viewing glasses when the glasses information does not satisfy the appropriate viewing condition.
